(19) United States
(12) Patent Application Publication
(10) Pub. No.: US 2008/0320276 A1
(43) Pub. Date: Dec. 25, 2008

(54) Digital Computing Device with Parallel Processing

(76) Inventors: Heinz Gerald Krottendorfer, Wien (AT); Karl Heinz Grabner, Probstdorf (AT); Manfred Riener, Wien (AT)

Correspondence Address: SCHNECK & SCHNECK, P.O. BOX 2-E, SAN JOSE, CA, 95109-0005, US

(21) Appl. No.: 11/997,874

(22) PCT Filed: Aug. 4, 2005
(86) PCT No.: PCT/AT2005/000311

§ 371 Date: Aug. 19, 2008

(51) Int. Cl. G06F 9/00

(52) U.S. Cl. 712/28; 712/E09.001

(57) ABSTRACT

A digital processing device comprising a plurality of parallel processing units each coupled in parallel with one another. Each of the plurality of parallel processing units comprises at least one data memory storage unit; at least one input register coupled to the at least one data memory storage unit; and an arithmetic unit coupled to the at least one input register and configured to have synchronous command processing. A program execution control unit is coupled to each of the plurality of processing units and configured such that no processing clocks are required for synchronization of data transfer from the plurality of parallel processing units. At least one data bus is coupled to the at least one input register in each of the plurality of parallel processing units.

### CROSS-REFERENCE TO RELATED APPLICATION

This application claims priority under 35 USC §119 from Patent Application PCT/AT2005/000311, filed 4 Aug. 2005, under the Patent Cooperation Treaty.

### TECHNICAL FIELD

The present invention relates generally to a digital computing device with parallel processing, and more particularly, to a digital computing device having several arithmetic units for parallel use and a control unit assigned thereto.

### BACKGROUND

Parallel-processing computer devices or processors are more and more often required for different applications; one example for such an application is digital signal processing in telecommunications. These applications require higher and higher processing powers in the circuits provided for digital processing, also referred to as digital signal processors (DSP).

In principle, for increasing the processing or processor power for such computational intensive tasks, there are two possibilities. Namely, increasing the processing clock frequency on the one hand and multi-implementation of computer components on the other hand. Concerning the first possibility, increasing the clock frequency is a common goal and preset or restricted by the respective current technology. For increasing the processing power, a high clock frequency can only be provided by a computer chip designer under certain circumstances, and usually this possibility is inherently fully utilized. In contrast, a potential that can be influenced to a greater extent by the chip designers is in the second method of multi-implementation of computer components.

A common example of the multi-implementation of computer components is “super-pipelining” computer. Here, the computer contains a chain of arithmetic units as processing stages, and it processes instructions not only successively, but interleaves in the individual processing stages, the so-called “pipeline stages.” A command is only completely processed when all of the processing stages of the arithmetic unit are run through. The individual processing stages are temporally decoupled; therefore several commands can be simultaneously processed within the arithmetic unit. For example, a new command is processed in the first processing stage, the previous command is simultaneously processed in the second processing stage etc. Therefore, the full performance can only be achieved if all of the pipeline stages are filled with instructions. However, if a jump into another program portion is provided in the program that is forming the instructions, which occurs relatively often, at first all of the commands processed in the individual stages of the arithmetic unit have to be processed and only thereafter it can jump to the new program portion, wherein the individual stages of the arithmetic unit then have to be filled again. Only thereafter the full parallel processing power is made usable again.

In another known computer architecture for increasing processing power, the “superscalar-computer,” instead of a long “pipeline-chain” (as in the “super-pipelining-computer”), shorter processing paths arranged in parallel, so-called pipelines, are implemented. Accordingly, here commands are actually processed in parallel instead of only being processed successively in an interleaved manner, as in the previously mentioned super-pipelining structure. However, this is disadvantageous in that the individual parallel units are not allowed to access to the same resources, such as the same data memories, to allow for using the entire processing power, but this cannot be excluded in practice.

According to another proposal for increasing processing power, several digital signal processors are used which are synchronized with each other via data interfaces. The synchronization of the digital signal processors is effected by means of a protocol which ensures that the completely autonomously operating signal processors exit the normal program processing and are brought into a state in which their transmitting side is ready to transmit data and their receiving side is ready to receive data. Then, the desired data exchange occurs with subsequent acknowledgment of successful data reception. Subsequently, the signal processors can again continue with the normal processing of the program. This kind of synchronization is time consuming but is required as the signal processors operate completely autonomously and thus do not have any information about the state of the respective other signal processors at the beginning of the processing. Consequently, in this technology the required synchronization substantially decreases the processor power as a whole as data throughput between the signal processors increases.

There is also known a technology, called PACT-XPP-architecture, wherein programmable cells (i.e., objects), are provided. (See, e.g., http://www.pactcorp.com/xneu/download/xpp_white_paper.df, “The XPP White Paper, Release 2.1, A Technical Perspective: PACT Informationstechnologie GmbH; Copyright 27 Mar. 2002.) By corresponding configuration, these objects are interleaved with each other such that the respective desired application is mapped. In order to effect a functional application, these objects themselves have to be correctly interleaved (i.e., configured) with each other as well as additionally appropriately programmed. For this association of the objects with each other therefore, a switchable (i.e., configurable) data connection network is required. In operation, synchronization is then effected by the data packets to be processed. Concretely, a data exchange between the objects occurs by data packets. That is, a target object receives all of the data packets from different transmitting objects. The target object synchronizes on these data packets; it waits until all of the required input data are available which are required for the desired calculation in the object, and only then it performs the calculation.

Thus, it is desirable to avoid at least some of the disadvantages of the prior art, and to propose a digital processing device with parallel processing which has an increased processing power for computational intensive tasks, wherein an actual processing power increase corresponding to the complexity can be achieved by parallelizing.

### SUMMARY

In various exemplary embodiments, a digital processing device is disclosed herein comprising a plurality of parallel processing units each coupled in parallel with one another. Each of the plurality of parallel processing units comprises at least one data memory storage unit; at least one input register coupled to the at least one data memory storage unit; and an arithmetic unit coupled to the at least one input register and configured to have synchronous command processing. A program execution control unit is coupled to each of the plurality of processing units and configured such that no processing clocks are required for synchronization of data transfer from the plurality of parallel processing units. At least one data bus is coupled to the at least one input register in each of the plurality of parallel processing units.

Another exemplary embodiment discloses a digital processing device for vector and scalar processing of digital data. The plurality of parallel processing means comprises a pair of data memory storage means for receiving the digital data, a pair of input storage means for holding the digital data for processing, and an arithmetic unit coupled to the pair of input storage means and configured to have synchronous command processing. The digital processing device further comprises a control means for synchronizing data between the plurality of parallel processing means without requiring a processing clock, at least one data bus coupled to the pair of input storage means in each of the plurality of parallel processing means, and a global processing means coupled for providing general computational support to the plurality of parallel processing means.

### BRIEF DESCRIPTION OF THE DRAWINGS

The appended drawings illustrate exemplary embodiments of the present invention and must not be considered as limiting its scope.

FIG. 1 schematically shows an exemplary embodiment of a structure of a digital processing device with parallel connected processing units in a block diagram.

FIG. 2 shows an exemplary digital processing device in a block diagram similar to FIG. 1 with processing units illustrated in a simplified manner.

FIG. 3 shows an exemplary operation of a central program execution control state diagram.

FIG. 4 shows an exemplary operation of program execution control in a simplified flow diagram.

FIG. 5 shows an exemplary processing device in an application of a true vector processing in a block diagram similar to FIG. 1. Individual data bus connections being active are illustrated in bold lines to clarify the parallel operation of the individual processing units.

FIG. 6 is an exemplary calculation scheme which may be employed in vector processing.

FIG. 7 is an exemplary scheme for execution of a typical program which may be employed in true vector processing.

FIGS. 8-10 and 11-13 are exemplary block diagrams similar to schemes shown in FIGS. 5-7 for exemplifying an operation in vector processing with scalar end result (FIGS. 8-10) or in scalar processing (FIGS. 11-13).

### DETAILED DESCRIPTION

Various embodiments of the digital processing device of the present invention can be used for processing computational intensive algorithms such as, for example, algorithms used in telecommunications, such as with image compression or in the DSL technique (DSL—digital subscriber line). In such applications and others, algorithms to be implemented are often composed of vector algorithms. That is, algorithms which process not only a single data value but a group of data values, a “data vector,” by congenial operations. Vector algorithms are in contrast to scalar algorithms calculating in turn a single data value starting from a single data value. However, the present digital processing device is suited to processing vector algorithms as well as processing scalar algorithms or combinations of scalar algorithms and vector algorithms. In one embodiment, the processing device is a program controlled processing device with several arithmetic units implemented together with associated data memories, thereby obtaining parallel processing units, which are able to efficiently cooperate such that a processing power increases corresponding to the complexity is actually achieved by parallelizing. For this cooperation, an appropriate control is of importance in the manner that data transfer between the arithmetic unit and the associated data memories are not only effected within the individual processing units, but data transfer is also enabled among the parallel processing units.

Further, a global or external data input and data output with the aid of corresponding bus systems is provided. In the case of providing at least one global processing unit, bus connections between the parallel processing units and this global processing unit are also provided. As a whole, it turns out to be especially advantageous that the required processing power is supplied by the provided parallel processing without requiring restrictions in synchronization measures through data transfer or the like, that vector algorithms can be efficiently processed, and that the processing of scalar algorithms is also effectively supported. In other words, embodiments of the present computer architecture enables the desired high processing power by “massive” parallel processing, wherein the parallel processing units optimally cooperate with each other, such that the desired processing power increase is actually achieved by parallelizing. This is of greater importance as data transfer rates (also the rates at which data enter and exit a computer) become increasingly higher in modern applications, especially in telecommunications.

Also, data transfers between the parallel processing units in the processing device are increasingly frequent, which is unproblematic with the present processing architecture in contrast to the multi-processor systems according to the prior art. Such prior art systems are unsuitable for such applications, as they require an additional temporal synchronization complexity for data exchange between the processors that is too high.

In the present processing device, clocks for the synchronization of data transfers are not required. Rather, efficient general coordination of all computations occurs in the processing units. In particular embodiments described herein, all actions in the processing device are in a rigid temporal association with each other and at any time it is exactly defined which data are available in the system just at the moment—and where. This is the presumption for no clock cycles being required for the synchronization of data transfers. This coordination may occur by the central program execution control. That is, all of the operations in the computer are in rigid and unique temporal interrelation with each other under the control of the central program execution control. Data transfers between the individual processing units can therefore be effected immediately, without temporal synchronization effort.

Thus, there are provided data bus connections for internal data transfers within the individual processing units as well as data bus connections for data transfers between the parallel connected processing units. Additionally, data bus connections are provided for general data input and output in and from the processing device, respectively. In a case of providing a global processing unit for general calculations, data bus connections are also provided between the global unit and the parallel connected processing units.

For efficient parallel processing, a separate program memory may be assigned to each of the parallel connected processing units. In a case of providing the global processing unit, a separate program memory may be assigned to the latter. In order to satisfy any processing requirements, the global processing unit may be connected to outputs as well as inputs of the parallel connected processing units.

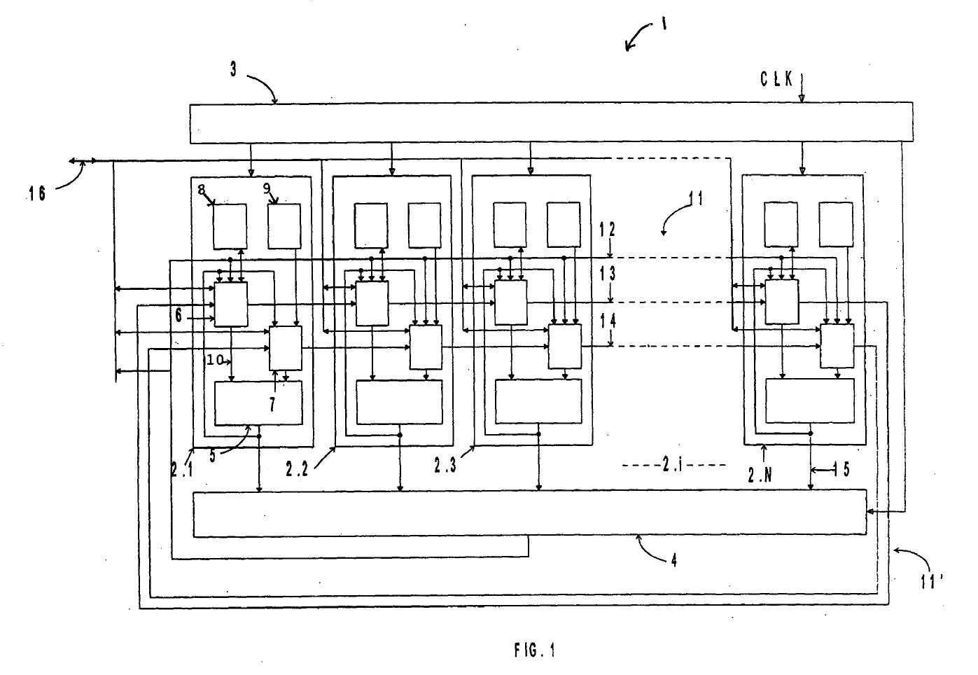

With reference to FIG. 1, a digital processing device 1 having parallel processing includes a number N of processing units (also called slices) 2.1, 2.2, 2.3, . . . , 2.N are connected in parallel to each other, is provided. A central, common program execution control unit 3 is assigned to the parallel connected processing units 2.1 to 2.N, below briefly designated by 2.i (where i=1 to N). The program execution control unit 3 also controls a global unit 4 connected to the parallel processing units 2.i.

Each of the parallel processing units 2.i comprises, as especially apparent in FIG. 1, at a first processing unit 2.1 an arithmetic unit 5 connected to input registers 6 (input register A) and 7 (input register B) for data to be processed. Further, two data memories 8 (data memory A) and 9 (data memory B) are provided in each of the processing units 2.i. For example, see processing unit 2.1 in FIG. 1 from which the data to be processed are transferred into the input registers 6, 7 in order that they can be processed in the arithmetic unit 5 in the desired manner.

From the above it is readily discernible that a data bus system 10 for internal data transfers between the data memories 8, 9 or input registers 6, 7 and the arithmetic unit 5 is provided within each of the parallel processing units 2.i. Further, a data bus system 11 is also provided for data transfer between the individual parallel processing units 2.1, 2.2, . . . , 2.N. The data bus system 11 includes a global data bus 11.1, a register A data bus 12 and a register B data bus 14 for data transfer between the parallel processing units 2.i. An additional data bus system 15 serves for data transfer between the parallel processing units 2.i and the global unit 4. A general data bus system 16 allows for external data inputs and outputs, respectively, to supply data to be processed to the processing device 1 or to deliver the results of the computations from the digital processing device 1.

Each of the individual data bus systems 10 to 16 is explained in more detail below by way of FIG. 5, 8, or 11, respectively, with the bus connections drawn with bold lines, according to the type of data processing to be performed.

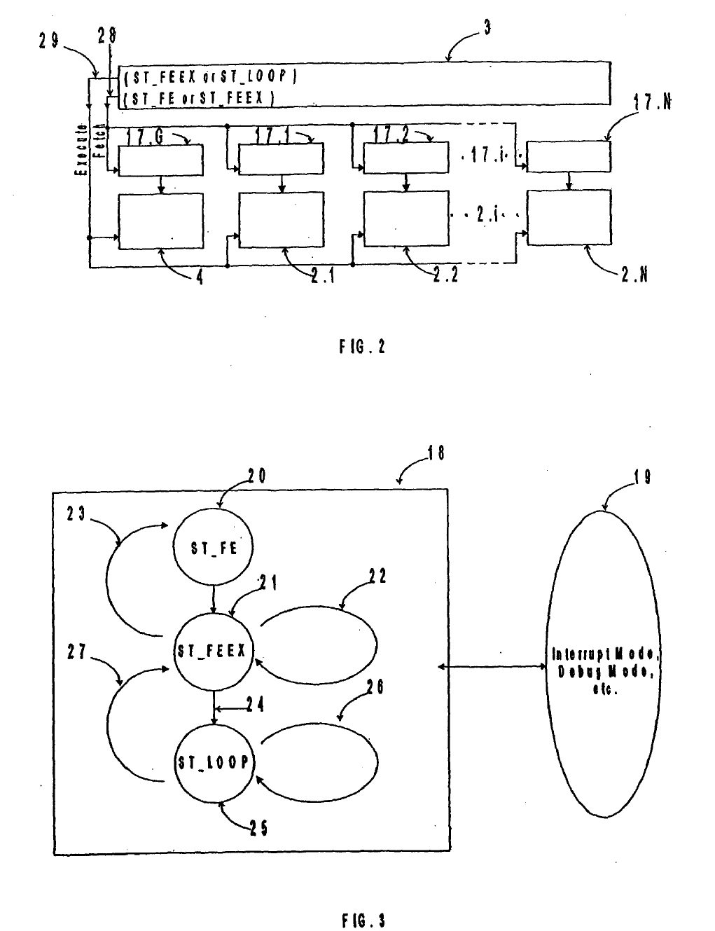

In the digital processing device 1 described so far, the individual parallel processing units 2.1 operate as autonomous parallel units. Each of the parallel processing units cooperates with respective separate independent data memories 8, 9 including an integrated address generator and a separate program memory (not shown, explained below with reference to FIG. 2). A separate, additional temporal synchronization work for data exchange between the arithmetic units 5 of the processing units 2.i is omitted by virtue of the central program execution control unit 3, such that no processing clocks are required for the synchronization of data transfers. Instead, an efficient global coordination of all calculations is effected in the parallel processing units 2.i simply in that all of the actions in the digital processing device 1 are in a rigid temporal relation to each other, which is given by the program execution control unit 3. In this manner, it is exactly defined at any time, which data are present at which point in the digital processing device 1. By this parallel operation of the individual parallel processing units 2.i, the potential processing power of the digital processing device 1 can be increased by a factor of N.

In detail, as will be explained in more detail by way of FIG. 5 et seq., for efficient processing of the vector algorithm in processing vector algorithms, the latter can be uniformly divided among the assigned computer resources, which is effected in two courses:
a) Assigning architecture resources: Starting from individual input data vectors the calculation of the entire data vector is divided among each of the parallel processing units 2.i, which in turn each calculate partial vectors of the entire data vector.
b) Assigning temporal resources: In each of the parallel processing units 2.i, individual data values of a partial vector are processed in a command loop. The program run is controlled centrally in the program execution control unit 3, whereby it is assured that the calculation of the vector algorithms is synchronously effected in all of the parallel processing units 2.i.

In a vector calculation, congenial operations are executed on the individual data values of a data vector. Usually, a calculation cycle is composed of an arithmetic operation linking each of two values to each other, wherein one of the two values is normally the data value of the data vector and the second value is a coefficient. Each of the parallel processing units 2.i includes two independent data memories 8, 9 as mentioned. Thus, an operation can be performed with two values in a single cycle, as required. The data bandwidth of the entire digital processing device 1 is thus optimized for vector algorithms. In vector processing, all of the assigned parallel processing units 2.i perform congenial calculations. Thus, computer resources of all parallel processing units 2.i are also always completely utilized.

Each parallel processing unit 2.i can be programmed individually (i.e., independently). Therefore, scalar algorithms independent of each other can be processed in the individual parallel processing units 2.i. A rigid synchronization of all of the parallel processing units 2.i in the digital processing device 1 is effected by the central program execution control unit 3. In calculating several concatenated scalar algorithms, this has the advantage that no additional processing clocks (see the clock input CLK in FIG. 1) are required for synchronization in data transfers between individual scalar algorithms being processed in different ones of the parallel processing units 2.i.

In certain applications, an efficient use of the digital processing device 1 may require a balanced division of the algorithms to be calculated in the parallel processing units 2.i. If, for example, the first processing unit 2.1 is busy with a first scalar algorithm requiring 100 cycles, the result of which is required for a second scalar algorithm, which in turn is calculated in the second processing unit 2.2 and only requires 10 cycles, then, the second processing unit 2.2 is only used during 10 cycles, and it then waits 90 cycles to the next result of the first processing unit 2.1. The effective use of the processing resources is then only (100+10)/(2×100)=55%. However, there are several degrees of freedom in partitioning algorithm calculations among the parallel processing units 2.i such that a high utilization of the parallel computer resources should always be possible:
(a) Dividing scalar algorithms among the individual parallel processing units 2.i, such that a uniform load is effected. Therein, individual ones of the parallel processing units 2.i can process a different number of algorithms. For example, if one of the processing units 2.x calculates two algorithms, wherein the first algorithm requires four processing cycles and the second requires five processing cycles, and a second processing unit 2.y calculates a third scalar algorithm requiring nine processing cycles, then both processing units 2.x and 2.y are fully busy for a total of nine cycles.
(b) Mixing the processing of scalar algorithms with vector algorithms such that again all of the parallel processing units 2.i are uniformly busy. For example, in an embodiment of the digital processing device 1 having eight parallel processing units 2.1 to 2.8, four of the parallel processing units 2.1 to 2.4 can process one vector algorithm, while the remaining four parallel processing units 2.5 to 2.8 process scalar algorithms in parallel (i.e., simultaneously). Similarly, another partition can be selected, for example, in the ratio of 6:2.

In this connection, it is also important that a separate program memory 17.1, . . . , 17.i, . . . , 17.N (see FIG. 2) is assigned to each of the parallel processing units 2.i, as already mentioned and a separate program memory 17.G is also associated to the global unit 4. In FIG. 1, the separate program memories 17.i are to be envisioned as components included in the program execution control unit 3.

The program execution control unit 3 controls program execution in a state machine 18, as is further apparent from FIG. 3. The state machine 18 determines when operations have to be carried out (“executed”) according to the software program and when a new command has to be retrieved (“fetched”). The program execution control unit 3 controls the program execution, as mentioned, centrally for all of the parallel processing units 2.i. In case of a special treatment in the digital processing device 1, the program execution control unit 3 is stopped, and appropriate steps are initiated in a separate state machine. Special treatments are, for example, the treatment of a “debug mode” (testing programs in the digital processing device 1 by stepwise program execution) or stopping the program execution control unit 3 until new data are supplied to the digital processing device 1, wherein a program interrupt is triggered (“interrupt mode”) as is exemplified in FIG. 3 with a special mode block 19.

The program execution control unit 3 has the following states according to the state machine 18 of FIG. 3.
(1) A “Fetch” state 20 (“ST_FE”): In the Fetch state 20 “ST_FE,” an address of a subsequent program command is taken from a PC register (PC: program counter; addressing of a program memory) (not illustrated in detail), and the program command addressed thereby is fetched from the program memory 17.i (i.e., “Fetch”). Subsequently (i.e., in the following clock), this program command is available for execution (“=Execute”).
(2) A “Fetch & Execute” state 21 (“ST_FEEX”): In the “Fetch & Execute” state 21, a new program command is fetched from the program memory 17.i. Subsequently (i.e., in the following clock), this program command is available for execution. The program counter is automatically incremented in each clock cycle in the “ST_FEEX” state 21. Thereby, the next program address is again available immediately. As the new program address, “PC+1” is thus assumed, see also the action 22 in FIG. 3. With the action 22, it is further exemplified that the command fetched in the preceding clock is executed. All of the parallel processing units 2.i and the global unit 4 are activated and the program commands assigned to respective ones of the parallel processing units 2.i are executed.
   In the “Fetch & Execute” state 21 “ST_FEEX” (see the actions 23, 24), it is further verified whether a program command changes the program sequence. This can relate to two possible types of commands: (1.) Loop commands: If a corresponding command marks the beginning of a program loop, a jump is made to a state 25 “ST_LOOP” explained below (see action 24), where the program loop is executed (see action 26 in FIG. 3). (2.) Commands directly changing the PC register: A jump in the program is triggered by loading the PC register with the next program address to be jumped to. Thus, the next command to be executed is not at the following address of the command just executed. Therefore, the command automatically fetched in the state “Fetch & Execute” 21 “ST_FEEX” from the address PC+1 has to be discarded. In order to fetch the command actually to be executed next from the program memory, a jump is made from the state “Fetch & Execute” 21 “ST_FEEX” to the state 20 “ST_FE” (see action 23).
(3) Loop state 25 (“ST_LOOP”): In the loop state 25 “ST_LOOP,” the execution of a program loop is effected. Only when the program loop is completely executed, a jump is made back from the loop state 25 “ST_LOOP” to the “Fetch & Execute” state 21 “ST_FEEX” (see action 27). During the loop state 25 “ST_LOOP,” a number of consecutive commands defined by the program are repeatedly executed. The number of the cyclical repetitions of the program loop is also preset by a separate command by the program.

The execution of program commands is accordingly affected for the entire digital processing device 1 in the state “Fetch & Execute” 21 “ST_FEEX” and during a program loop in the loop state 25 “ST_LOOP.” If the state machine 18 is in one of these states, all of the parallel processing units 2.i in the digital processing device 1 are activated, and they execute the commands preset by the program (see also the indications “Fetch” and “Execute” as well as the state indications “ST_FEEX” or “ST_LOOP” and “ST_FE” or “ST_FEEX” in FIG. 2).

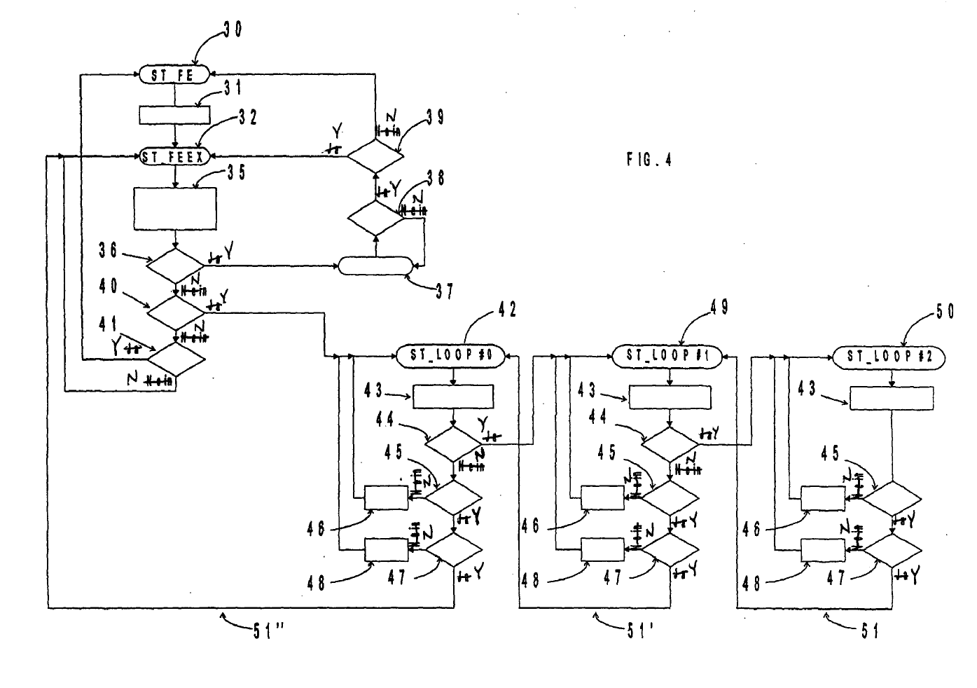

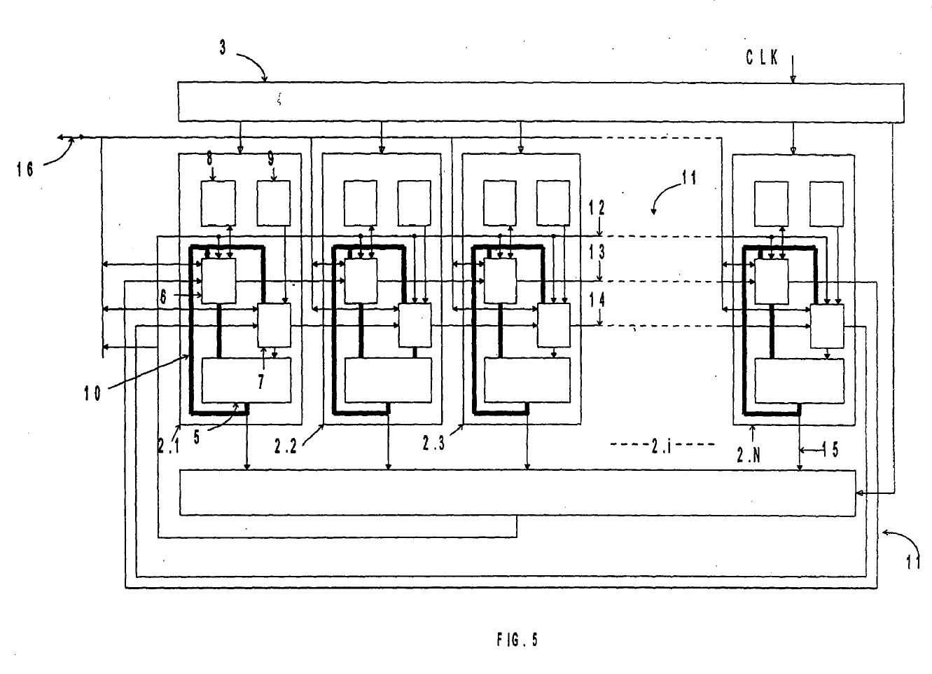

In FIG. 4, a signal flow diagram of the program execution control unit 3 (FIG. 1) is exemplified, wherein the previously mentioned Fetch state 20 (“ST_FE”), “Fetch & Execute” state 21 (“ST_FEEX”) and loop state 25 (“ST_LOOP”)—the latter with interleavings—are also exemplified.

The program execution control unit 3 is controlled by program. In detail, exemplary commands of the program execution control unit 3 are explained by way of the flow diagram of FIG. 4. However, in dependency of the configuration of the digital processing device 1, it can be reasonable to add further commands.

In FIG. 4, in the left portion, a normal program processing is exemplified, wherein, according to the state ST_FE, see field 30, first, the next command—according to block 31—is fetched from the actual address PC. The next command can then be expected at the address PC+1. Thus, the command automatically fetched from this location can be executed in the next cycle.

In the following “Fetch & Execute” state 21 (“ST_FEEX”) according to FIG. 3, the execution of the program begins (see field 32 in FIG. 4). According to block 35, the execution of the command is then prepared and all of the parallel processing units 2.1 and the global unit 4 are activated for this, as well as the next command is fetched at the address PC+1. This command is again discarded if there is no continuous program execution.

Then, according to field 36, it is queried whether a special treatment (see the special mode block 19 in FIG. 3) is to be started, and if so, it proceeds to the special treatment field 37. Thereafter, according to field 38, it is cyclically queried whether the special treatment is completed, and if no, the special treatment is continued according to field 37. However, if the special treatment is finished (output YES of field 38), according to another field 39, it is queried whether a continuous program execution is given, wherein the next command at the address PC+1 is considered. If a continuous program execution is given, see output YES of field 39, it proceeds to the “ST_FEEX” state according to field 34. However, if there is no continuous program execution, see output NO of field 39, it returns to the starting state 20 “ST_FE” according to field 30.

If in the query step according to field 36, the result is obtained that no special treatment is to be performed, thereafter, it is queried according to field 40 whether a program loop is to be started (i.e., if a jump to the loop state 25 “ST_LOOP” has to be made), and if no, according to field 41, the presence of a continuous program execution is again queried. If true, then it returns to the state according to field 30. However, if the query result at the field 41 is no, the command address is increased by “1,” and a jump is made to the state “ST_FEEX” according to field 34.

If the result in the query according to field 40 is that a program loop is to be started, it proceeds to the loop state 25 “ST_LOOP,” (i.e., concretely in the present example according to FIG. 4 with three interleaved loop possibilities to the first, outermost loop No. 0, according to field 42).

Such a program loop is triggered by the command “START_LOOP.” Therein, the state 34 “ST_FEEX” is exited and a jump is made to the first loop beginning with the field 42 “ST_LOOP#0” in the example according to FIG. 4, as mentioned. Then, the current value of the program counter PC and the current command are stored to provide preparation “Enable” of the command execution, see block 43 in FIG. 4. For this, at the end of a loop, the first command within the loop is repeated, which corresponds to a program jump, as the next program line is not at the location PC+1. Thus, the next command would have to be fetched again in an additional cycle, as with jump commands into the state 34 “ST_FEEX,” which effect an additional-fetch-state “ST_FE” according to field 30. In order to optimize the loop execution, which is particularly important in vector algorithms, accordingly, such an additional intermediate step is avoided in that the first command of the loop with the value in the program counter (PC) is latched and thus is immediately available. In a loop execution, therefore, no cycles are lost when jumping back to the loop start.

In the example according to FIG. 4, a total of three interleaved loops are provided, as mentioned, which are exemplified in FIG. 4 in the right half thereof, side-by-side, each beginning with a field “ST_LOOP” #0, #1, or #2. In the first loop with No. #0, it is now queried according to a query field 44 whether an inner loop is to be started, and if no, in another query field 45 it is queried whether the loop is completed. If no, the next command is fetched according to block 46 and it is returned to the loop start (i.e., to field 42). However, if the loop is processed, it is queried according to a query field 47 whether the last loop has already been reached, that is, whether the loop counter is at the preset maximum value “LOOPMAX.” If no, the first command is fetched from the command register for the next loop, as mentioned (see block 48), and the loop counter is increased by 1.

In detail, the loop end is indicated by a command “STOP_LOOP.” If a loop end is indicated in this manner, it is verified whether already sufficient passes of the loop have occurred, which is the case when the loop counter has reached the preprogrammed value “LOOPMAX,” as mentioned. If this is the case, the loop processing is deemed completed, and the normal program execution at the field 34 “ST_FEEX” is continued. Otherwise, as mentioned, the next loop pass is started by increasing the value of the loop counter.

The re-occurrence of the command “START_LOOP” in the loop state 25 “ST_LOOP” (FIG. 3) is to be understood as presence of a nested loop, which is detected in FIG. 4 at the query field 44. When such a nested or interleaved loop is detected, a jump is made to this nested loop, for example, with No. #1 in FIG. 4 (see field 49), and then loop processing occurs analogous to the previously described one, wherein in FIG. 4 the corresponding fields and blocks are given in this nested loop #1 as in the outermost loop #0, and wherein new explanations thereof can be omitted. A similar process applies also to the next nested loop, the loop #2 according to field 50 in FIG. 4. However the query field 44 is omitted here as there exists no further nested loop. In FIG. 4, by connections 51, 51′, 51″ it is indicated that if the respective loop 50 etc. (or 49 etc., or 42 etc., respectively), is processed, it returns to the respectively next higher loop, namely to the beginning thereof according to field 49 or 42, respectively, or to the field 32, respectively.

Thus, in the program execution control exemplarily illustrated and explained in FIG. 4, a three-fold interleaved loop is provided, wherein the innermost loop is controlled in the state “ST_LOOP #2” (see field 50). By latching the current program counter value as well as the current command at the jump into the next loop hierarchy, it is again prevented that a cycle is lost by an additional program fetch upon return to the first command of the respective loop. If the command “STOP_LOOP” is encountered, the next loop pass is started or a jump is made back to the next higher loop hierarchy or to the field 34 in FIG. 4, respectively, if the loop counter has reached the maximum loop value “LOOPMAX” (see query field 47).

In order that all of the loop hierarchies (i.e., “ST_LOOP” #0 to #2) are independent of each other, a corresponding number of, here three, loop counters and “LOOPMAX” registers are provided. Similarly, there are corresponding storage locations for all of the three loop hierarchies to each store the first command of a loop together with the program counter value therein.

In the digital processing device 1 (FIG. 1), in which the program execution is synchronous for all of the parallel processing units 2.i, a change of the program flow relates to all of the parallel processing units 2.i at the same time. Fetching new commands from the different program memories 17.i (FIG. 2) is encountered centrally by the program execution control unit 3 in the Fetch state 20 or the “Fetch & Execute” state 21 (i.e., “ST_FE” or “ST_FEEX,” wherein “Fetch” is activated). By this central control, at each time it is uniquely determined which commands are processed in a certain clock cycle.

All of the parallel processing units 2.i obtain a common activation signal from the program execution control unit 3. It is active, if the program execution control unit 3 is in the “Fetch & Execute” state 21 “ST_FEEX” (normal program flow) or in the loop state 25 “ST_LOOP” (processing of a program loop), and it thus synchronizes all operations in the digital processing device 1. Since both the command fetch and the command execution are affected synchronously, the entire processing in the digital processing device 1 is rigidly coupled. Therefore, it is determined at each time and for each of the parallel processing units 2.i, which commands are currently processed. By this rigid synchronization, no further effort is required to synchronize data transfers between different ones of the parallel processing units 2.i.

The digital processing device 1 described up to now in particular supports efficient processing of three classes of algorithms, namely the true vector processing, the vector processing with scalar end result, and the scalar processing. Processing of these algorithms is explained in more detail below.

In the true vector processing, input data respectively constitute a data vector, that is, a set of individual data values, and the result is again a data vector, thus a set of individual data values. In the digital processing device 1, an autonomous parallel processing of individual values of the input data vectors is executed in individual ones of the parallel processing units 2.i. No data transfer between the parallel processing units 2.i is required, as is especially apparent from FIG. 5, where the active data bus systems 10 within the parallel processing units 2.i are exemplified with bold lines.

The N parallel processing units 2.i receive input data from the data memories 8, 9 or from outside through the external data input (i.e., the general data bus system 16). The data are passed to the input registers 6, 7 which in turn serve the respective one of the arithmetic unit 5 which executes corresponding arithmetic operations. The result can again be returned to the input registers 6, 7 through a slice-internal (i.e., parallel processing unit-internal) data bus in order to permit an iterative calculation. Alternatively, one of the two input registers 6, 7 can also fetch data for the next processing cycle from the associated data memory 8, 9 respectively. Thereafter, the calculation in the arithmetic unit 5 is effected again. The end result can either be restored into the data memories 8, 9 via the input registers 6, 7 or it is output through the external data output (i.e., the input/output general data bus system 16).

A duration of the entire processing is preset by the central program execution control unit 3, which is programmable. Thus, the duration of the entire calculation, i.e., the number of the processing cycles to be repeated, is determined by program. By the rigid synchronization through the central program execution control unit 3, it can be exactly determined when individual ones of the parallel processing units 2.i provide results. Therefore, further synchronization work is not required, for example, in order to synchronize a data transfer to subsequent and further processing programs, respectively.

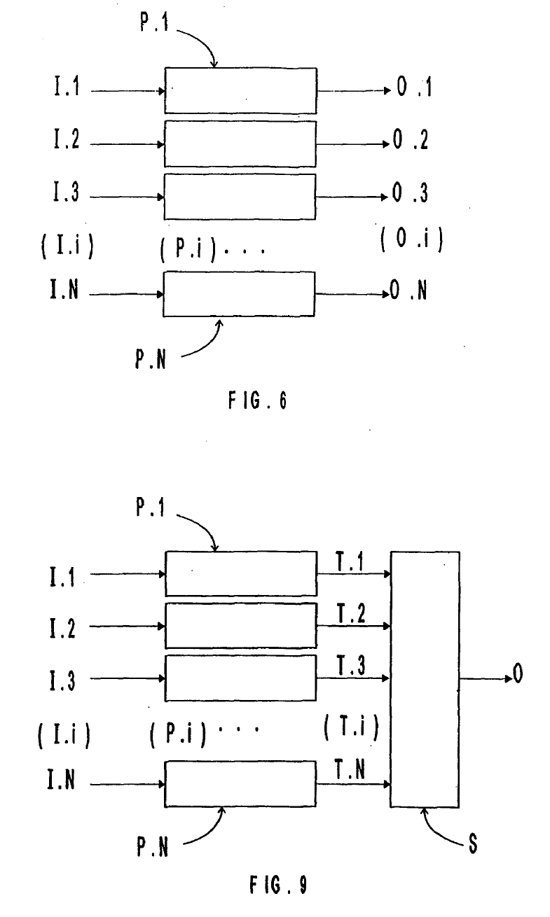

As exemplified in FIG. 6, in which at Iᵢ (with i=1, 2, 3, . . . , N) input values (thus the input data vector as a whole), at Pᵢ the parallel processing activities, and at Oᵢ the results (the output data vector) are shown, the global unit 4 is inactive in this true vector processing.

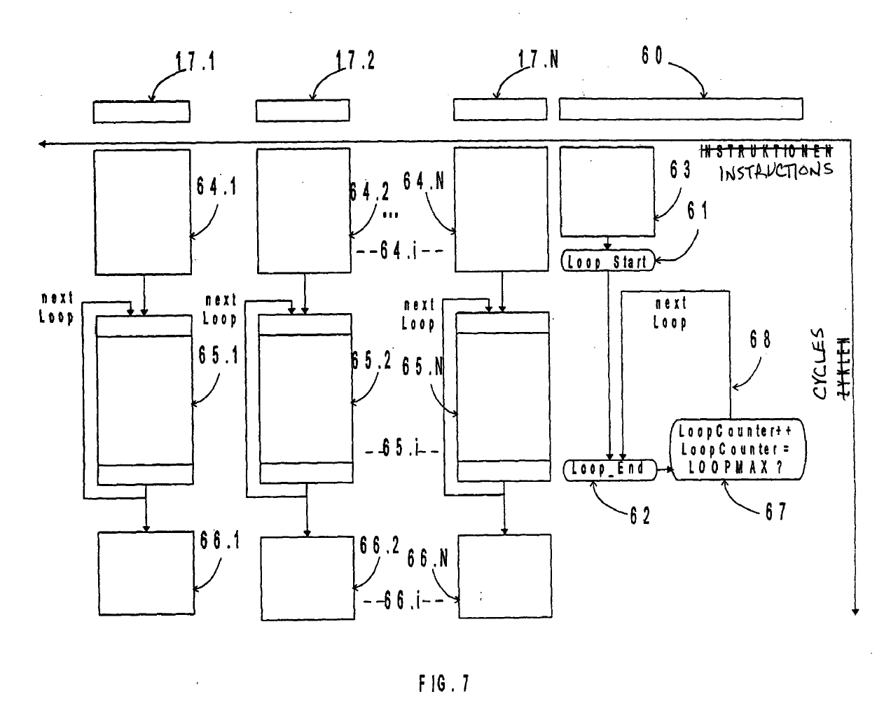

In FIG. 7, execution of a program typical for the vector processing is shown. Commands controlling the program execution control unit 3 (FIG. 1) are taken from a common program memory 60 containing general commands. Individual ones of the parallel processing units 2.i are controlled via the separate program memories 17.i. The iterative calculation starts with the command “Loop Start,” see field 61 in FIG. 7). All commands (exclusively that command line in which there is the command “Loop Start”) up to the command “Loop End” (see field 62) are repeatedly executed. The number of repetitions is preset in a “LOOPMAX” register, the loading of which is schematically shown in FIG. 7 at the block 63. The command “Loop-Start” for starting the loop calculation follows according to field 61. All program memories 17.i are controlled via the common program counter (PC). Therefore, the entire processing is always effected line by line, wherein each individual program line is divided among the individual program memories 17.i and the general program memory 60. All partial programs in the individual always 2.i—pre-calculation 64.i, iterative calculation 65.i, post-calculation 66.i—consist of program commands freely selectable for each of the parallel processing units 2.i, which are taken from the respective program memory 17.i. Only the program flow is centrally controlled. For example, the number of the iterative calculations is determined by loading the “LOOPMAX” register for all of the parallel processing units 2.i. According to the field 67, it is respectively verified whether the loop count has reached the maximum loop number (“LOOPMAX”), and if not, the next loop is calculated (see also the “connection” 68 “next loop” in FIG. 7).

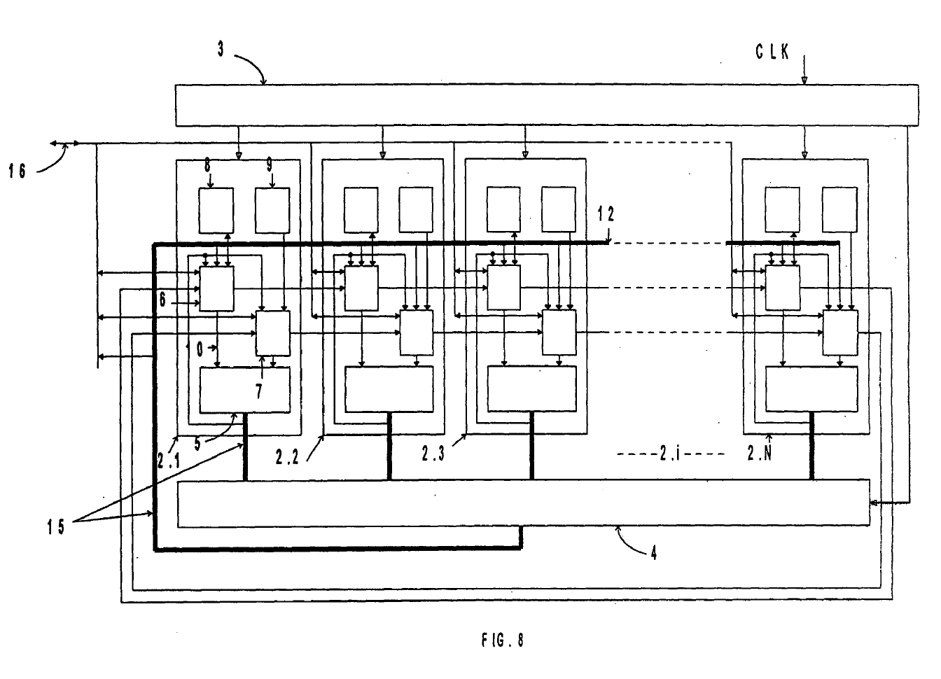

Next, the vector processing with a scalar end result is to explained by way of FIGS. 8 to 10. In this kind of processing, the input data also form a data vector (a set of individual data values). However, the result is a scalar quantity, that is, a single data value. In individual ones of the parallel processing units 2.i, vector processing of the individual values of the data value is effected, whereupon the formation of a scalar end result is effected in the global unit 4. This end result can be returned to all of the parallel processing units 2.i. These processing activities, or the data transfers to be performed for this, respectively, result from FIG. 8, in which again starting from the scheme of FIG. 1, the bus systems 12 and 15, which are in particular active now, are strongly highlighted.

The processing of the input data vector is again effected as already previously described by way of FIGS. 5 to 7, and does not have to be further explained. Subsequent to this vector processing, the partial results of the calculations effected in individual ones of the parallel processing units 2.i are passed to the global unit 4. This global unit 4 takes the partial results of the parallel processing units 2.i and forms an individual end result by arithmetic operations (for example, the global unit 4 can form the sum or also a scalar product from all partial results).

Except that the end result can again be returned to the input registers 6, 7 of individual ones of the parallel processing units 2.i, it is of course also conceivable to output the scalar end result through the external output (thus over the general data bus system 16).

This mixed form of processing is in turn schematically exemplified in FIG. 9 in a representation similar to FIG. 6. Therein, it is shown how partial results Tᵢ are calculated from input values Iᵢ in a vector processing Pᵢ. From these partial results Tᵢ, the scalar end result 0 is calculated in a global scalar calculation S, for example, by product calculation.

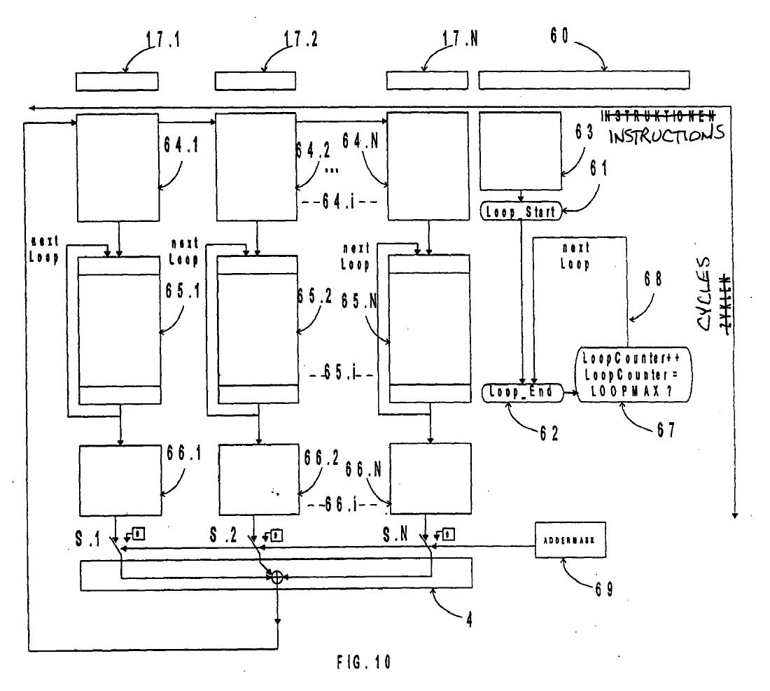

FIG. 10 shows the execution of a typical program in more detail. Therein, the iterative calculation again is effected centrally for all of the parallel processing units 2.i. In the example shown, the starting values of a calculation are taken from the global unit 4 (which, for example, functions as a global adder) at the beginning of the calculation. As all of the parallel processing units 2.i can be separately programmed, each of the parallel processing units 2.i can take the starting data from another source. For example, it would also be possible that only the first of the parallel processing units 2.1 takes its starting value from the global unit 4, and other of the parallel processing units 2.i (i±1) obtain their starting values from the data memory or from outside (e.g., over the general data bus system 16).

According to FIG. 10, selected values are summed up in the global unit 4 at the end of the calculation, which is exemplified by driving switches S.i. The selection, which slice values are summed up, is determined by a register 69 “ADDERMASK.” Incidentally, FIG. 10 basically corresponds to FIG. 7, such that repeated description, such as concerning the loop processing activities, can be omitted.

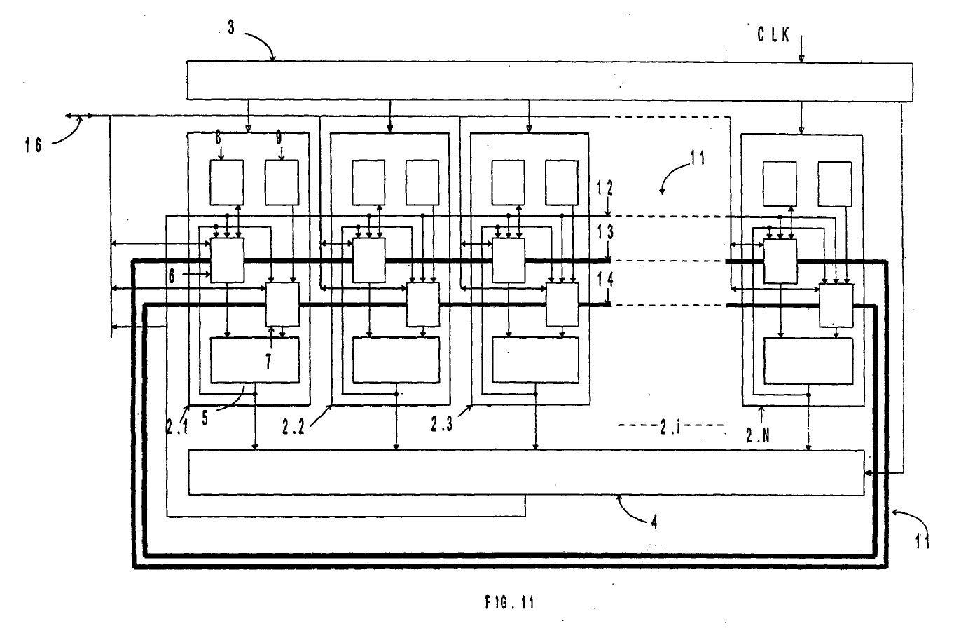

Subsequently, by way of FIGS. 11, 12 and 13, an exemplary pure scalar processing is to be explained. Here, the input data are a scalar quantity (a single data value) as well as the end result and intermediately obtained partial results are scalar quantities (single data values). The entire calculation is divided in partial calculations effected in parallel in individual ones of the parallel processing units 2.1, 2.2, . . . , 2.(N−1), 2.N, and all partial results are passed simultaneously to the respective right neighbouring unit 2.2, . . . , 2.N, 2.1, where the respective further calculation is effected. In FIG. 11, it is shown with a bus system 11′ that a ring structure is formed as a whole, wherein it results that the “right” neighbor of the processing unit 2.N is the processing unit 2.1.

FIG. 12 shows the calculation of a chain A.1, A.2, A.3, . . . , A.N (generally A.1) of scalar algorithms (i.e., the entire calculation is divided in partial calculations A.1). The individual calculation stages are processed in adjacent processing units 2.1, 2.2, 2.3, . . . , 2N. The transfer of the partial results is effected via the data bus 11 or 11′, respectively, concatenating the input registers 6, 7 of individual ones of the parallel processing units 2.i with each other (see FIG. 11). If the partial results T1.i are finally calculated, the end results of the individual partial calculations A.1 are set into the input registers 6, 7 of individual ones of the parallel processing units slices 2.i. The input register 6 or 7 of the respective right neighbor slices 2.(i+1) can access this result over the data bus 11 or 11′, respectively, and use it as starting value for the next calculation cycle. Thus, the entire calculation results from a chain of partial calculations T1.i, T2.i, . . . , as illustrated above. Each of the parallel processing units 2.i can programmably connect into this chain. By the rigid synchronization of individual ones of parallel processing units 2.i by the program execution control unit 3, no further calculation clocks are required for passing the data values between the parallel processing units 2.i. The data bus connection 11, 11′ of the input registers 6, 7 of the parallel processing units 2.i is connected in ring-shaped manner. Therefore, all of the parallel processing units 2.i are equivalent, and no slice is preferred or disadvantaged by its position (Example: the rightmost slice 2:N has the first slice 2.1 as the “logical” right neighbor).

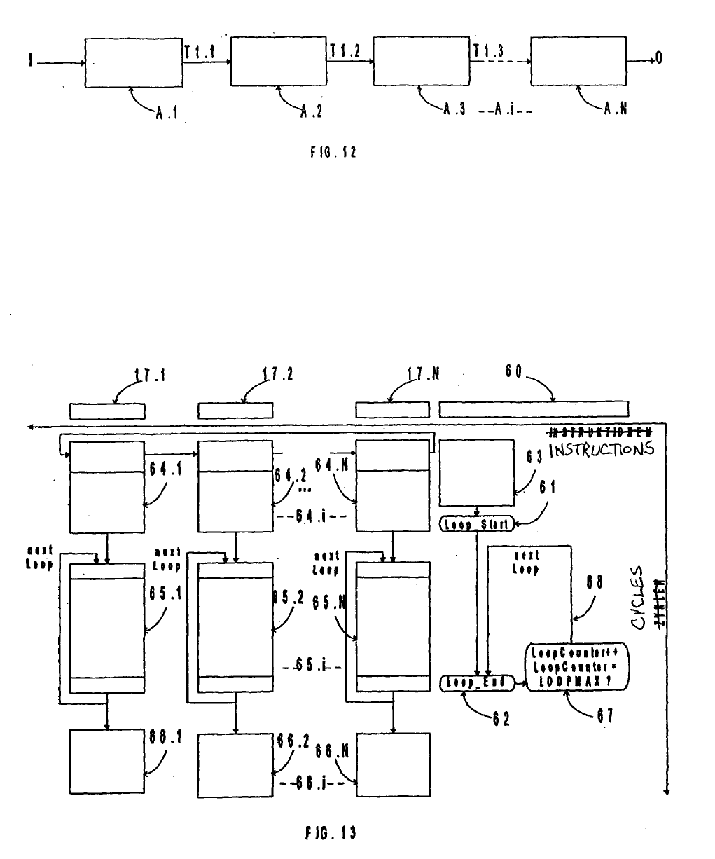

In FIG. 13, the execution of a typical program is shown, wherein the execution of the partial programs in the parallel processing units 2.i is controlled by the separated slice program memories 17.i. The starting values are taken from the respective left neighboring slice. This is effected in that—as exemplified in FIG. 13 at 70.i—via programming, all command registers are assigned to the slice input port as data source, which is coupled to the command register output of the respective left neighboring slice. Therein, the central program execution control unit 3 greatly facilitates the synchronous data takeovers between all slices. The synchronization is achieved in that enabling the input register data buses 13, 14 is effected in the respectively same program line of each of the parallel processing units 2.i.

A ring-shaped concatenation of all command registers in the first program line is illustrated here. Indeed, each of the parallel processing units 2.i can be programmed completely independent. The capability of passing data from one processing unit to the other through the register data bus 13 or 14, respectively, is only determined in that in the same program line of the two concerned slice partial programs in one slice 2.(i−1) the data value is made available and it is taken over in the second slice 2.i by means of connecting the register bus 12 or 13. The respectively concerned slice pairs 2.(i−1), 2.i can freely select whether and when a data transfer between the slices is established.

Mixing the above mentioned algorithm types is also possible. Therein, different ones of the parallel processing units 2.i of the digital processing device 1 can simultaneously process different algorithm types. Different algorithm types can be treated consecutively, and the digital processing device 1 can switch between the algorithm types without requiring additional calculation clocks.

All of the parallel processing units 2.i can be programmed autonomously for themselves and therefore perform calculations independently. Connection of the parallel processing units 2.i is effected with the data bus structure optimally supporting the discussed algorithms. Basically, different algorithm types can also be assigned to the parallel processing units 2.i for calculation, which is effected in that both the operations executed in the parallel processing units 2.i and the connection of the data paths is flexibly defined by a program and can be altered at any time. Moreover, since all of the parallel processing units 2.i can be separately programmed, it is possible that different algorithm types can be processed simultaneously in different processing units.

The present invention is described above with reference to specific embodiments thereof. It will, however, be evident to a skilled artisan that various modifications and changes can be made thereto without departing from the broader spirit and scope of the present invention as set forth in the appended claims. For example, particular embodiments describe a number of processing units and logical elements per stage. A skilled artisan will recognize that these numbers and particular elements are flexible and the quantities and types shown herein are for exemplary purposes only. Additionally, a skilled artisan will recognize that various numbers of stages may be employed for various applications. Also, various embodiments may be implemented by hardware, firmware, or software elements, or combinations thereof, as would be recognized by a skilled artisan. These and various other embodiments are all within a scope of the present invention. The specification and drawings are, accordingly, to be regarded in an illustrative rather than a restrictive sense.

1-7. (canceled)

8. A digital processing device comprising:
a plurality of parallel processing units each coupled in parallel with one another, each of the plurality of parallel processing units comprising
at least one data memory storage unit;
at least one input register coupled to the at least one data memory storage unit; and
an arithmetic unit coupled to the at least one input register and configured to have synchronous command processing;
a program execution control unit coupled to each of the plurality of parallel processing units and configured such that no processing clocks are required for synchronization of data transfer from the plurality of parallel processing units; and
at least one data bus coupled to the at least one input register in each of the plurality of parallel processing units.

9. The digital processing device of claim 8 further comprising a general data bus system coupled to each of the plurality of parallel processing units.

10. The digital processing device of claim 8 wherein each of the plurality of parallel processing units further comprises an internal bus system coupling the at least one data memory storage unit, the at least one input register, and the arithmetic unit.

11. The digital processing device of claim 8 wherein each of the plurality of parallel processing units further comprises a second data memory storage unit and a second input register.

12. The digital processing device of claim 8 wherein each of the plurality of parallel processing units further comprises a separate program memory.

13. The digital processing device of claim 8 further comprising a global processing unit coupled to, and configured to provide general computational support to, each of the plurality of parallel processing units.

14. The digital processing device of claim 13 wherein the global processing unit is coupled through an additional data bus system both to an input and an output of each of the plurality of parallel processing units.

15. The digital processing device of claim 13 wherein the global processing unit comprises a separate program memory.

16. A digital processing device comprising:
a plurality of parallel processing means for vector and scalar processing of digital data, each of the plurality of parallel processing means comprising
a pair of data memory storage means for receiving the digital data;
a pair of input storage means for holding the digital data for processing; and
an arithmetic unit coupled to the pair of input storage means and configured to have synchronous command processing;
a control means for synchronizing data between the plurality of parallel processing means without requiring a processing clock;
at least one data bus coupled to the pair of input storage means in each of the plurality of parallel processing means; and
a global processing means coupled for providing general computational support to each of the plurality of parallel processing means.

17. The digital processing device of claim 16 further comprising a general data bus system coupled to each of the plurality of parallel processing means.

18. The digital processing device of claim 16 wherein each of the plurality of parallel processing means further comprises an internal bus system coupling the pair of data memory storage means, the pair of input storage means, and the arithmetic unit.

19. The digital processing device of claim 16 wherein each of the plurality of parallel processing units further comprises a separate program memory.

20. The digital processing device of claim 16 wherein the global processing unit is coupled through an additional data bus system both to an input and an output of each of the plurality of parallel processing means.

21. The digital processing device of claim 16 wherein the global processing unit comprises a separate program memory.
